(19) United States
(12) Patent Application Publication
(10) Pub. No.: US 2009/0260586 A1
(43) Pub. Date: Oct. 22, 2009

(54) HEAT EXCHANGER FOR AN INTERNAL COMBUSTION ENGINE

(75) Inventors: Peter Geskes, Ostfildern (DE); Jens Ruckwied, Stuttgart (DE); Jurgen Barwig, Vaihingen (DE)

Correspondence Address: LEYDIG VOIT & MAYER, LTD, 700 THIRTEENTH ST. NW, SUITE 300, WASHINGTON, DC, 20005-3960, US

(73) Assignee: BEHR GMBH & CO. KG, Stuttgart (DE)

(21) Appl. No.: 12/441,416

(22) PCT Filed: Sep. 19, 2007
(86) PCT No.: PCT/EP07/08158

§ 371 Date: Mar. 16, 2009

(30) Foreign Application Priority Data
Sep. 19, 2006 (DE) 10 2006 044 630.5

(51) Int. Cl. F01P 7/10; F02M 31/08; F28D 15/00

(52) U.S. Cl. 123/41.48; 165/52; 165/104.19

(57) ABSTRACT

The invention relates to a heat exchanger for cooling a fluid for an internal combustion engine, in particular, a gas, for example, in the form of a charge fluid such as exhaust gas, charge air, mixtures thereof or similar, in particular for an internal combustion engine on a motor vehicle, said exchanger preferably being a gas cooler, comprising an inner tubular piece (1) with a least one channel (3) and an outer tubular piece (2). According to the invention, a web (7) is arranged on at least one of the inner tubular piece (1), or outer tubular piece (2), said web (7) running to the other of the inner tubular piece (1) or outer tubular piece (2).

The invention concerns a heat exchanger to cool a fluid, which has an inner tubular part with at least one channel and an outer tubular part. The invention also concerns an exhaust gas recirculating system for an internal combustion engine and a use of the heat exchanger.

For internal combustion engines, especially of motor vehicles, various designs of heat exchangers, for example, gas coolers as in FR 2 507 759, have been proposed. Exhaust gas coolers for the cooling of recirculated exhaust gas for the reduction of pollutants are also known, in which bundles of separate flat tubes, made of stainless steel, are soldered at the end in common holding units, wherein the holding units, in turn, are soldered at the edge with a steel housing. Similar construction principles of coolers to cool a gas by means of a liquid have also been proposed for the cooling of compressed and heated charge air, wherein to cool the charge air, air-cooled heat exchangers have hitherto been primarily used.

From DE 103 49 887 A1, it is known that a cooler for an exhaust gas recirculating system has an increased heat exchange effectiveness with a reduced use of materials and installation expense. In this respect, the throughflow channel for the exhaust gas to be cooled is designed as a cooling profile which, with respect to its cross section, has a profile form with an outside surface enlarged to a circular form, wherein the cooling profile is sheathed by an outer tube through which the cooling medium, especially cooling water, flows.

From DE 203 01 920 U1 a heat exchanger is known with which at least one block, which contains two flow gaps running parallel to one another, and which are subdivided at their ends into different flow channels by two end pieces, which are sealed off from the surroundings, with each end piece provided with a channel connection to the supply and discharge pipes for the warm and the cold flow fluids. There the block consists of a one-part heat exchange element produced by an extrusion method, made of an aluminum alloy, with heat-exchanging walls connected in a substance-to-substance bonding manner between the flow gaps that are closed in the cross section.

From DE 199 36 241 A1 an apparatus for the cooling of gases is known in which the gas can be conducted through the channels of a cooling apparatus, wherein channels for a throughflowing cooling medium are present in the cooling apparatus in the vicinity of the channels for the gas. The cooling apparatus has the channels for the cooling agent in the center in the interior, and has channels for the gas to be cooled radially on the outside and an extruded aluminum profile part with cooling ribs as an intermediate unit.

From DE 198 09 859 A1 an apparatus for the cooling of gases is known in which the gas can be conducted through the channels of a cooling apparatus, wherein channels are also present in the cooling apparatus, in the vicinity of the channels for the gas, for a throughflowing cooling medium. The cooling apparatus has the channels for the cooling medium in the center in the interior, and has the channels for the gas to be cooled radially on the outside.

The objective of the invention is to specify a heat exchanger for an internal combustion engine which can be produced at a low cost and with simple means.

This objective is attained by the invention with a heat exchanger, mentioned at the beginning, for cooling a fluid for an internal combustion engine, in particular, a gas, for example, in the form of a charge fluid such as exhaust gas, charge air, mixtures thereof or the like, especially for an internal combustion engine of a motor vehicle, said exchanger preferably being a gas cooler comprising an inner tubular part with at least one channel and an outer tubular part. According to the invention, a web is located on at least one of these two parts, the inner tubular part or the outer tubular part, wherein the web extends up to the other of the two parts, the inner tubular part or the outer tubular part.

By means of the web extending from the inner to the outer or from the outer to the inner tubular part, a direct fitting together of the tubular parts is produced, so that completion of the tubular part into a gas cooler-for example, by means of suitable end caps for the supply and discharge of gas and cooling agent, can be implemented at low cost and in a simple manner.

The invention also leads to a use of the heat exchanger for a motor vehicle or for a rail vehicle or a power plant, in particular, a combined heating and power station.

Preferably, the fluid to be cooled, in particular, the gas, consists at least in part of compressed air for combustion, and/or at least partially exhaust gas from an internal combustion engine. Both compressed air for combustion and exhaust gas to be cooled, for example, recirculated exhaust gas, have high temperatures and make similar demands of a gas cooler with regard to decline in pressure and mass flow. If the gas contains exhaust gas from an internal combustion engine, the basic problems with regard to the high corrosiveness of the exhaust gas and its condensed products also have to be taken into consideration.

Other refinements of the invention can be deduced from the subclaims.

In the interest of a low-cost manufacture, at least one of the two tubular parts, the inner one or the outer one, is made as an extrusion profile. In this way complex shapes, above all to increase an exchanger performance, are enabled in a simple manner, since the extrusion profile can have largely arbitrary cross sectional forms.

With particular preference, the inner tubular part is made as an extrusion profile based on aluminum. In addition to the low-cost and easily feasible production of complex forms with this material, there has been the surprising effect that extrusion profiles, produced in the usual manner, based on aluminum or common aluminum, alloys exhibit a particularly low susceptibility to the chemical aggressiveness of hot exhaust gas. This effect could be caused by the special microstructure of the material that is formed during extrusion and subsequent cooling. It has been shown that by heating such corrosion-resistant extrusion profiles to high temperatures-for example, within the context of a soldering or welding process-the good corrosion characteristics can once again be lost. Care should therefore be taken, at least when using the apparatus as an exhaust gas cooler, that correspondingly high temperatures are no longer introduced into the material after extrusion, or in any case, are introduced only locally-for example, with the local welding of an end cap for the supply of the gas flow.

To improve the heat exchanger performance with a given design, provision is advantageously made so that the inner tubular part has a number of rib-like extensions, which project into the gas-conveying channel.

In a preferred embodiment, the inner tubular part has at least a second channel, with the second channel being constructed as a bypass channel with a reduced cooling of the throughflowing gas. Such bypass channels are common, in particular, with exhaust gas coolers, in order to take into account special operating conditions, for example, when cold starting the internal combustion engine. The bypass channel preferably has an insert, in particular consisting of a sheet metal part. In this way, a heat loss of the exhaust gas when flowing through the bypass channel is further reduced.

To create turbulences and/or longer flow paths and generally to improve the heat exchanger performance with a given design, provision is advantageously made so that at least one of the two tubular parts, inner or outer, has a twist around a longitudinal direction. By means of such twists, for example of the gas-conveying inner tubular part, in particular, rib-like extensions project into the channel to impart a twist or turbulence to the gas flow. In this way, heat exchange is improved for a given channel length and a given mass flow.

In a particularly preferable embodiment, provision is made so that the inner tubular part and the outer tubular part have at least one bend over their course. Such bends introduced into the tubular parts are suitable for optimally adapting the gas cooler to the available installation space. Particularly with internal combustion engines of motor vehicles, the installation space is very limited and frequently has an unfavorable shape. Since the inner tubular part and the outer tubular part are connected with one another via one or more webs, they can be bent jointly in a simple manner, so as to adapt the gas cooler to the installation space.

To simplify attaching connecting pieces for the supply and discharge of gas and liquid, the inner tubular part projects longitudinally beyond the outer tubular part.

In an advantageous embodiment, the inner tubular part and the outer tubular part are formed as separate parts, wherein, in particular, an insertion of the inner tubular part into the outer tubular part is forcibly guided by the web. In this way the tubular parts can consist of various materials, wherein, for example, the inner tubular part in contact with the hot gas can be a particularly corrosion-resistant or high-quality material, whereas the outer tubular part, which is only in contact with the liquid, can be of lower material quality for a cost savings. Moreover, a joint bending of the tubular parts inserted one into another is made possible in a particularly simple manner, since compressions and expansions in the vicinity of the bends can be compensated better via tubular parts that move relative to each other in the longitudinal direction.

As an alternative to this, however, provision can also be made so that the inner tubular part and the outer tubular part are constructed of the same material in one piece, especially by means of extrusion. In this way, a particularly low-cost production of the gas cooler is made possible, since the number of individual parts needed is reduced.

According to a particularly preferable refinement of the invention, at least one of the two tubular parts, preferably the inner tubular part, is constructed based on aluminum, especially as an extruded profile. According to another refinement of the invention, at least one of the two tubular parts, preferably the outer tubular part, is constructed based on plastic. A plastic hose, for example, has turned out to be particularly advantageous for the formation of the outer tubular part. Preferably, the web is formed integrally with the other of the two tubular parts, inner or outer, bonded substance-to-substance with the inner or outer tubular part.

In a particularly preferable combination of these refinements, the outer tubular part is formed as a plastic part and the inner tubular part is formed as an aluminum extruded part, on which the web, extending to the outer tubular part, is also directly, integrally formed-that is, is formed together with the inner tubular part within the extrusion process. The aforementioned embodiment has proved to be particularly advantageous with regard to a conveying of the fluid to be cooled, for example, the charge fluid, in the interior space of the inner tubular part, and for conveying of the cooling agent in the gap between the outer tubular part and the inner tubular part.

In an alternative embodiment, the cooling agent can also be conveyed in the interior space of the inner tubular part and the charge fluid, in the gap between the inner tubular part and outer tubular part-in this case the inner tubular part can if necessary be constructed as a plastic part and the outer tubular part as an aluminum part, or the inner and outer tubular parts can be formed together as a single aluminum extruded part.

In another embodiment, the two tubular parts can if necessary be formed as an aluminum casting, especially as a die casting or sand casting, preferably also with a housing of the heat exchanger. Both tubular parts can also be formed as a plastic part, depending on the demand and utility.

As a supplemental support between the outer tubular part and the inner tubular part, at least one or a number of other separate spacers can be provided between the inner and outer tubular parts, in addition to the webs extending throughout between the inner tubular part and the outer tubular part. An additional spacer is preferably made of plastic. An additional spacer is preferably connected with one or both of the tubular parts by means of a clip or crimp connection. Similarly, it is possible to place flow-conducting elements or turbulence-creating elements—and in particular, they can be attached by means of clip or crimp connections.

It is basically possible to form the arrangement of the inner and outer tubular parts, among the other ways as explained before, from at least two fluidically separated tubular parts, wherein according to the concept of the invention a web is placed on at least one of the two that extends up to the other one of the two.

The hydraulic properties of the tube arrangement can preferably be defined for a cross sectional area with a through flow within the framework of a hydraulic diameter. For example, the gap forms a hydraulic diameter between the outer tubular part and the inner tubular part—that is, in particular, an annular cross section or a cross section of an annular element; a hydraulic diameter is four times the cross sectional area with the throughflow, divided by the circumference of the cross sectional area with the throughflow. Similarly, the interior space of the inner tubular part forms a hydraulic diameter that is four times the cross sectional area with the throughflow, divided by the circumference of the cross sectional area with the throughflow.

The hydraulic diameter for the cross section of the tube arrangement which is penetrated by the fluid to be cooled is preferably in the range between 4 mm and 13 mm, in particular, between 7 mm and 10 mm. The hydraulic diameter for the cross section of the tube arrangement which is penetrated by the cooling agent is preferably in the range between 3.5 mm and 15 mm. In particular for the case in which a cooling agent is conveyed in the gap between the inner tube part and the outer tube part, a hydraulic diameter-preferably, for a cross section of an annular segment-between 5 mm and 7 mm has proved to be particularly preferable. A hydraulic diameter between 6.5 mm and 14 mm has proved to be particularly preferable for the case that the cooling agent is conveyed in the interior space of the inner tubular part preferably, for a circular cross section. As a whole, it has proved to be particularly appropriate that a gas-conveying cross section, in particular a tube, be a multiple of the hydraulic diameter of a cooling agent-conveying cross section, in particular a tube, especially one which is 0.5-4 times, especially, 1-2 times the diameter.

Moreover, it has proved to be particularly preferable for the length of the heat exchanger, especially the inner or outer tubular part, to be a multiple of the gas-side hydraulic diameter, in particular, 20-200 times, especially, 40-100 times the diameter.

Independently of the conveying of the fluid to be cooled and the cooling agent—whether in the gap between the outer tubular part and the inner tubular part, or in the interior space of the inner tubular part-the use particularly of an especially corrosion-resistant aluminum alloy for the formation of one or both of the tubular parts has proved to be particularly appropriate. An aluminum alloy with a comparatively good corrosion resistance has a comparatively low Cu fraction, especially a Cu fraction which is less than 0.5 wt %, in particular, smaller than 0.2 wt %, especially, smaller than 0.1 wt %. Basically, an Al-Mg-Si alloy or an Al—Zn—Mg alloy is suitable. An aluminum alloy used to form at least one of the tubular parts has proved to be surprisingly effective:

an Si fraction of less than 1.0 wt %;

an Fe fraction of less than 1.2 wt %

a Cu fraction of less than 0.5 wt %;

a Cr fraction of less than 0.5 wt %;

an Mg fraction of more than 0.02 wt % and less than 0.5 wt %;

a Zn fraction of less than 0.5 wt %;

a Ti fraction of less than 0.5 wt%;

the balance Al and unavoidable impurities.

In particular, especially advantageous characteristics of the alloy, especially with regard to corrosion resistance, have resulted in the case that the aforementioned fractions are concretely selected.

For example, an Si fraction can be below 0.6 wt %, especially below 0.1 wt %. An Fe fraction can be, in particular, below 0.7 wt %, especially below 0.35 wt %. Moreover, a Cr fraction above 0.05 wt % and below 0.2 wt % has proved to be particularly preferable, especially a Cr fraction above 0.1 wt % and below 0.2 wt %. An Mg fraction is particularly advantageous above 0.05 wt % and below 0.3 wt %. Moreover, a Zn fraction above 0.05 wt % and below 0.3 wt % has proved to be particularly preferable. A Ti fraction is preferably above 0.05 wt % and below 0.25 wt %. Moreover, the aluminum alloy can have another fraction of other metals and substances-for example, Mn, Zr, Ni, V, Co, PP, Ga and 0. Finally, the aluminum alloy can also have an arbitrarily different fraction-for example, an additive or the like, in the range of 0.05 wt % to 0.15 wt %.

For the further improvement of a corrosion resistance, it has proved particularly advantageous to provide an average particle size, measured in the extrusion direction, which is below 200 μm, in particular, below 100 μm, especially below 50 μm.

In a first variant, the inner tubular part has an inner space to convey the fluid to be cooled. Accordingly, the gap between the outer tubular part and the inner tubular part is designed to convey the cooling agent.

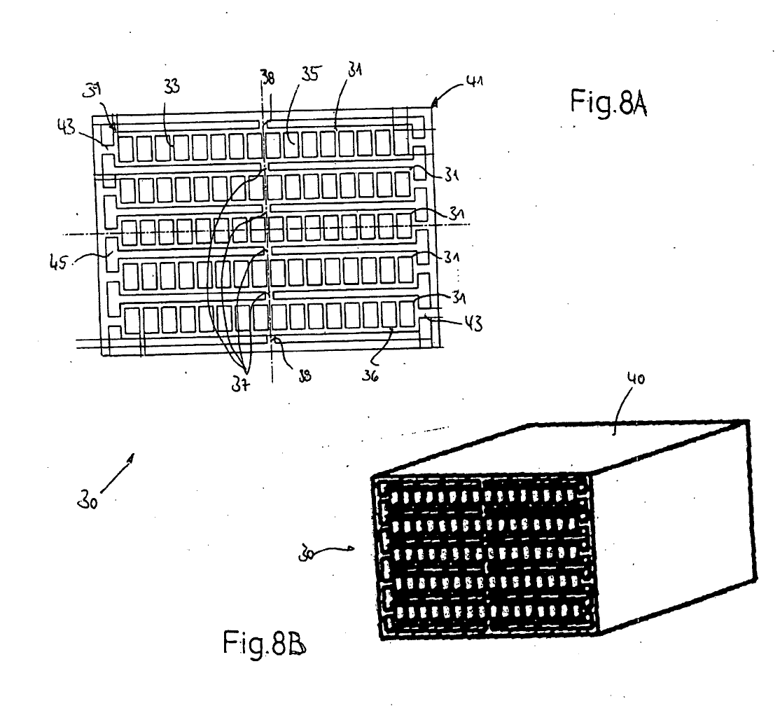

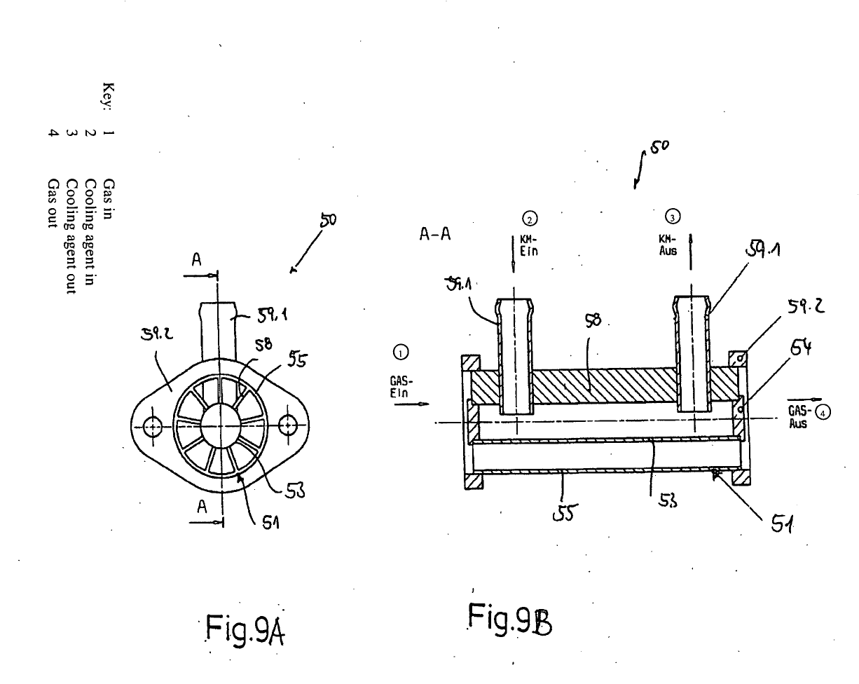

In particular, one inner tubular part has proved to be a particularly preferable refinement of the first variant, in addition to the refinements described above; it has at least one channel with segments that are connected with one another by spacer webs. Preferably, one segment has channels which are arranged next to one another in rows. Preferably, one segment consists of a single row of channels arranged next to one another. In a particularly preferable embodiment of this refinement of the first variant, described in more detail with the aid of FIGS. 8A, 8B, the arrangement of at least two, in particular, up to ten-five segments in the embodiment-channels, one upon the other, has proved to be advantageous. Likewise, it has proved to be advantageous for a segment to have between ten and twenty-in the embodiment mentioned, sixteen-channels. Preferably, a segment and/or a channel is formed with a rectangular cross section.

Conversely, in a second variant the interior space of the inner tubular part is designed to convey the cooling agent. Accordingly, the gap between the outer tubular part and the inner tubular part is designed to convey the fluid to be cooled.

In a particularly preferable refinement of the second variant, the design of the interior space of the inner tubular part with an essentially circular or elliptical cross section has proved to be particularly advantageous. A cooling agent conveyance and a connection to supply and/or discharge the cooling agent can thus be obtained in a particularly easy manner with a low flow resistance. Preferably the cross section is formed as a round cross section. Such a cross section is arranged, in particular, as a central, interior cross section. In a preferred refinement, an interior space of the inner tubular part can also have a cross section that has at least one radial extension connected at the central circular or elliptical cross section. In particular, a radial extension from an outer tubular part can be limited in its periphery. Refinements of this type therefore have an overall star-shaped cross section with an essentially circular or elliptical central part. In one modification, a central cross section or an interior cross section of the inner tubular part can also be angular, for example, rectangular.

In a preferred refinement, in particular of the second variant, a gap-in particular, that is, an annular cross section-between the outer tubular part and the inner tubular part is divided by the at least one web into segments, preferably, circular segments. It has been shown that preferably, the formation of segments supports the cooling of the fluid to be cooled in a particularly effective manner with a conveyance of the fluid to be cooled in the gap. In addition, it has proved to be advantageous for a partial web to project with a free end in the gap between the outer tubular part and the inner tubular part. This advantageously increases the heat exchange or the heat-exchanging surface between the cooling agent and the fluid to be cooled. A partial web can be placed or shaped on an outer tubular part or on an inner tubular part and can project into the gap. Preferably, a partial web is extruded with the tubular part.

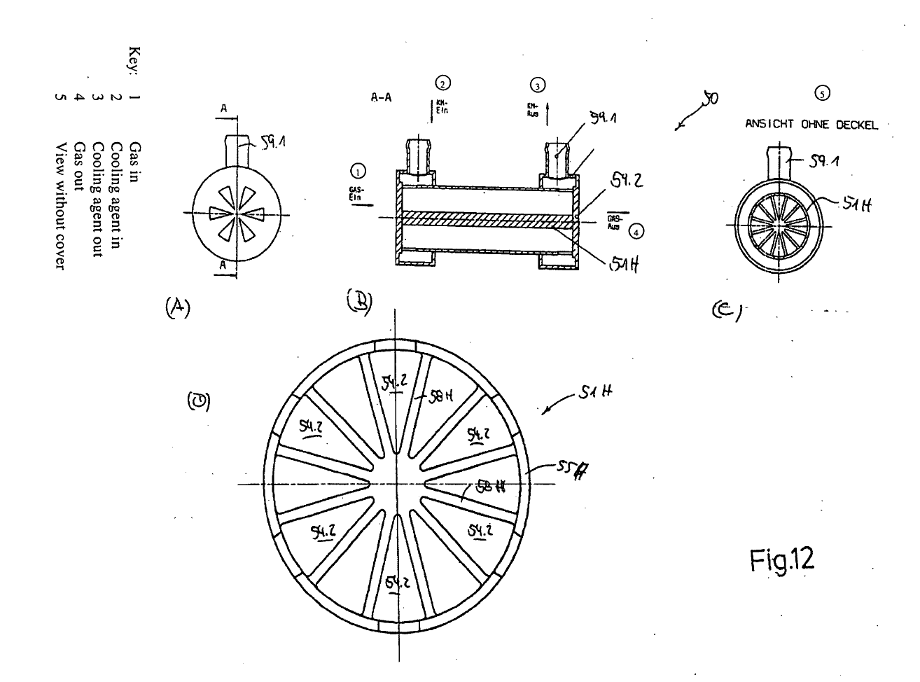

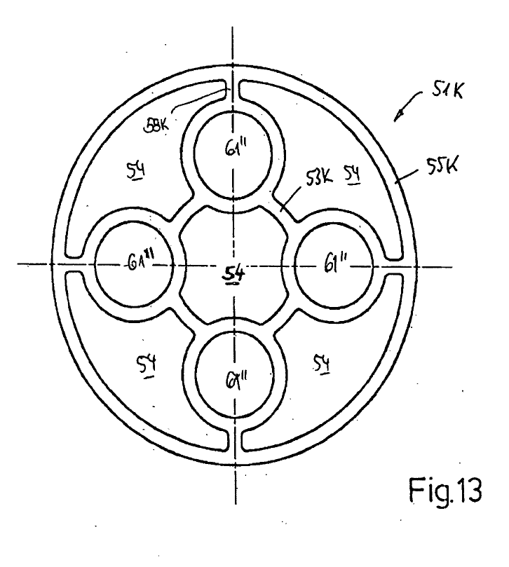

In a third variant, it has proved to be particularly advantageous for segments of the aforementioned type to be designed so that they will alternately receive the throughflow of the cooling agent and the fluid to be cooled. Thus, for example, embodiments as they are shown in FIGS. 12 and 13 have proved to be particularly effective in heat exchange.

The aforementioned refinements of the invention, in particular the refinement according to the first, second, and third variants, can be provided with a supply and/or discharging of the fluid to be cooled and/or of the liquid cooling agent in a particularly simple yet advantageous manner via a supply connecting part and/or a discharge connecting part.

In a particularly preferable refinement, a connecting part can be provided as a single connecting part. For example, at least one connecting part to the channel can be provided for the supply and/or discharge of the fluid to be cooled, and/or of the fluid cooling agent, between the inner and outer tubular parts. Such a connecting part, provided jointly for the cooling agent and the fluid to be cooled, can in particular be readily constructed as a connecting part for a refinement according to the first variant.

A single common connecting part for the supply and/or discharge of the fluid to be cooled can also be designed between the inner and outer tubular part and/or of the liquid cooling agent, in the interior space of the inner tubular part-that is, according to the refinement of a second variant.

Such a connecting part, which receives a throughflow both of cooling agent and also of the fluid to be cooled, can preferably be provided as the supply connecting part and/or the discharge connecting part. Such a connecting part preferably has a first fluid path for the fluid to be cooled and a second fluid path for the cooling agent. It has proved particularly advantageous for the first fluid path to be oriented axially and/or the second fluid path radially, to the extension of the tubular parts. With regard to construction, this makes possible a particularly advantageous connection of an interface for the cooling agent and/or the fluid to be cooled that at the same time has a low flow resistance.

A supply connecting piece and/or a discharge connecting piece can, additionally or alternatively, also be formed from a number of separate connecting parts. In particular, a first connecting part can be designed for the throughflow of only the fluid to be cooled, and a second connecting part for the throughflow of only the cooling agent. In this respect, a supply connecting part and/or a discharge connecting part can have a separate cooling agent connecting part and a separate connecting part for the fluid to be cooled.

Within the framework of the aforementioned refinement, it has proved to be particularly advantageous for a cooling agent connecting part, preferably in the form of a connecting piece, to be arranged at an opening into a gap between the inner and outer tubular parts. Such an opening can be formed, in a particularly advantageous manner, in the outer tubular part-this corresponds to the design of a connecting part with respect to the aforementioned first variant of a refinement of the invention.

According to an aforementioned second variant of the refinement of an invention, it is possible to arrange a cooling agent connecting part, preferably, in the form of a connecting piece, at an opening into an interior space of the inner tubular part, in particular, to fix it at an opening of the inner tubular part.

According to the principle of the first variant of a refinement, it has proved advantageous to arrange the opening in an end section of the outer tubular part. Preferably, an end section can be free of a web. In this way, an inflow space for cooling agent is formed in a particularly advantageous manner in the gap in the vicinity of the end section of the outer tubular part. According to the principle of the second variant of a refinement, the opening can be placed in an end section of the outer and inner tubular part-this makes possible the introduction of cooling agent directly into the interior space of the inner tubular part.

Another connecting part for the fluid to be cooled, separate from the previously explained connecting part, is preferably formed as a flange-in particular, as a flange through which the fluid to be cooled is conducted. Thus, according to the principle explained above of the first variant of a refinement, a connecting part for the fluid to be cooled can be held by the inner tubular part and/or can cover the gap between the inner and outer tubular parts. According to the principle of the second variant of a refinement, the connecting piece for the fluid to be cooled also can be held by the outer tubular piece and/or can cover the channel or interior space of the inner tubular part.

In both cases, a particularly advantageous connection-according to the first variant-of the central interior space of the inner tubular part or-according to the second variant-of the peripheral gap between the inner tubular part and the outer tubular part is obtained.

According to a preferred embodiment, a gas cooler is inserted into an exhaust gas recirculating system for an internal combustion engine with a supply conduit for combustion air to supply air for combustion to an inlet of the internal combustion engine, an exhaust gas conduit to remove exhaust gas from an outlet of the internal combustion engine, and an exhaust gas recirculating conduit to return exhaust gas from the exhaust gas conduit to the supply conduit for combustion air.

In a particularly preferable manner, the exhaust gas recirculating system has a compressor in the supply conduit for combustion air and a turbine in the exhaust gas conduit, wherein the exhaust gas recirculating conduit is placed on the high pressure side or on the low pressure side of the exhaust gas turbocharger.

Embodiments of the invention will now be described below with the aid of the drawing. The embodiments will not necessarily be depicted true to scale; rather the drawing is executed in schematic and/or slightly distorted form wherever that is useful for the explanation. With regard to additions to the teachings evident from the drawing, reference is made to the relevant state of the art. One should thereby take into consideration that diverse modifications and changes can be undertaken regarding the form and detail of an embodiment, without deviating from the general idea of the invention. The features of the invention disclosed in the description, the drawing, and the claims, both individually and in an arbitrary combination, can be essential for the refinement of the invention. Moreover, all combinations of at least two of the features disclosed in the description, the drawing, and/or the claims fall within the framework of the invention. The general idea of the invention is not limited to the exact form or detail of the embodiment shown below and preferably described, nor restricted to an object which would be limited in comparison to the object claimed in the claims. In the indicated dimension ranges, values found within the mentioned limits, which are limit values, are also intended to be disclosed and to be arbitrarily usable and claimable.

Other advantages and features can be deduced from the embodiments described below, and from the dependent claims.

Two preferred embodiments of a heat exchanger according to the invention in the form of a gas cooler are described below, and are explained in more detail with the aid of the adjoining drawings.

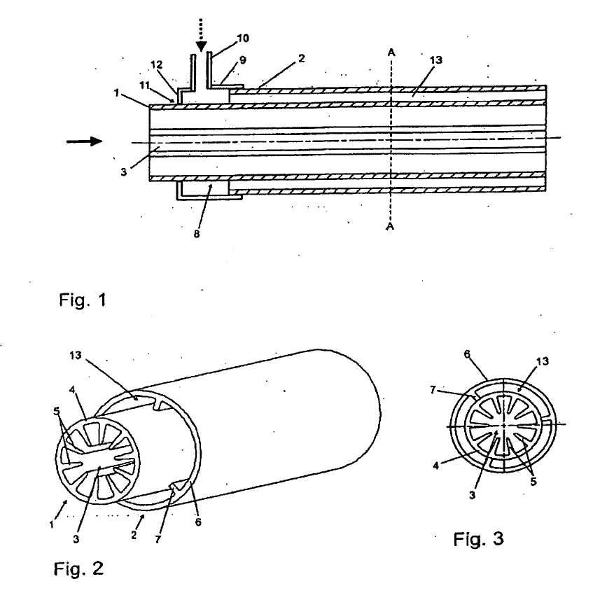

FIG. 1 shows a schematic longitudinal section of a first embodiment of a gas cooler according to a first variant of a refinement;

FIG. 2 shows an oblique partial view of the gas cooler from FIG. 1;

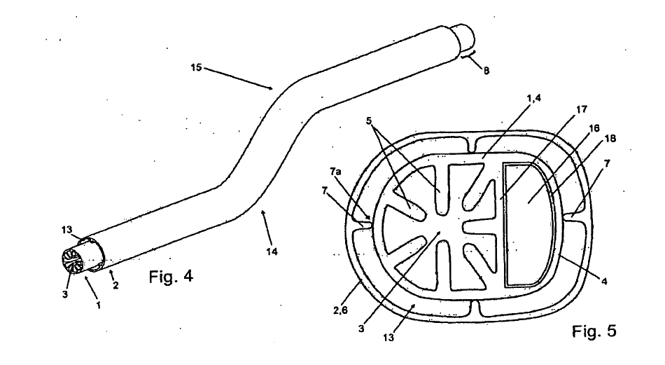

FIG. 3 shows a cross section of the gas cooler from FIG. 1 along line A-A;

FIG. 4 shows another oblique partial view of the gas cooler from FIG. 1;

FIG. 5 shows a cross section of a second embodiment of a gas cooler according to a first variant of a refinement;

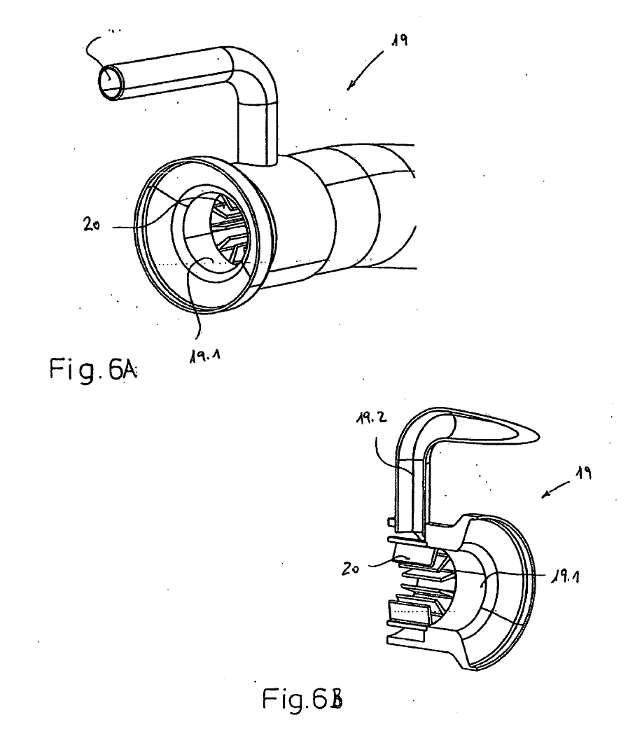

FIGS. 6A-6B show a preferred embodiment of a connecting part for the joint conveyance of cooling agent and gas for an embodiment of a gas cooler according to a first variant of a refinement;

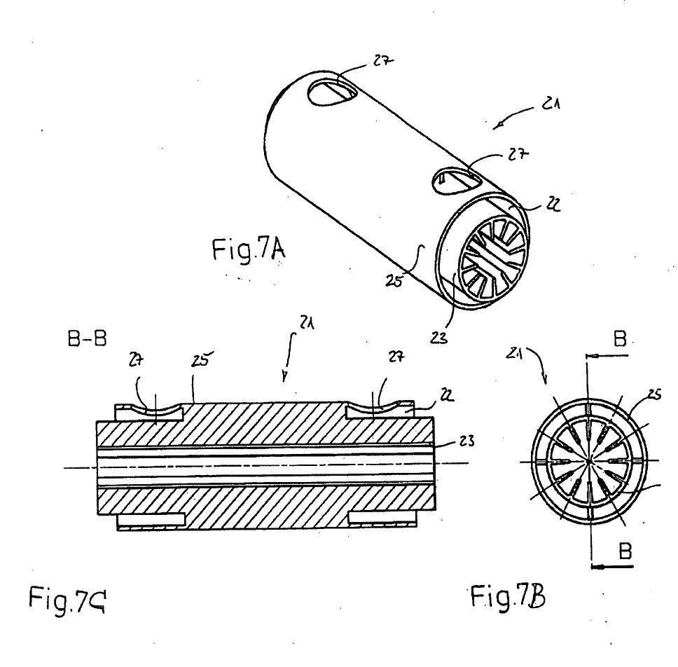

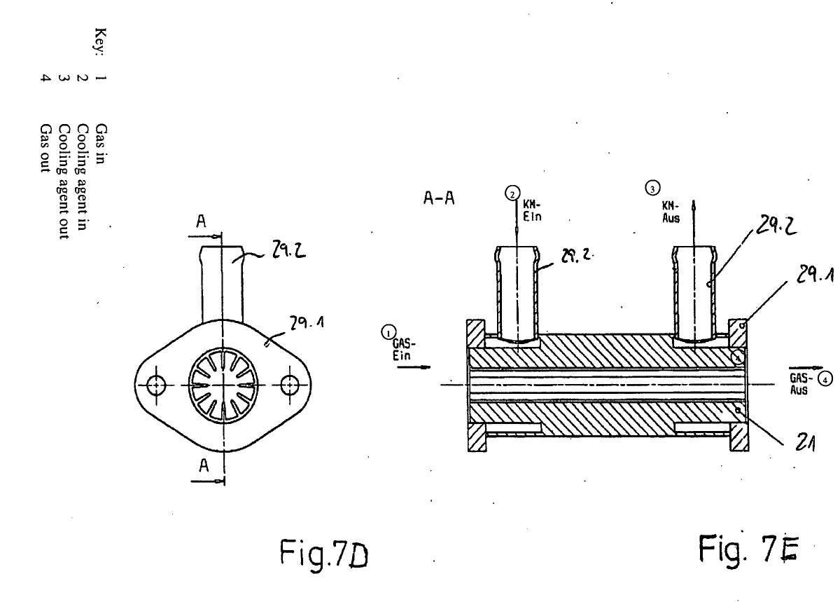

FIGS. 7A-7E show another preferred design of a connecting part for the separate conveyance of the cooling agent and gas for an embodiment of a gas cooler according to a variant of a refinement;

FIGS. 8A-8B show a second embodiment of a gas cooler according to a first variant of a refinement;

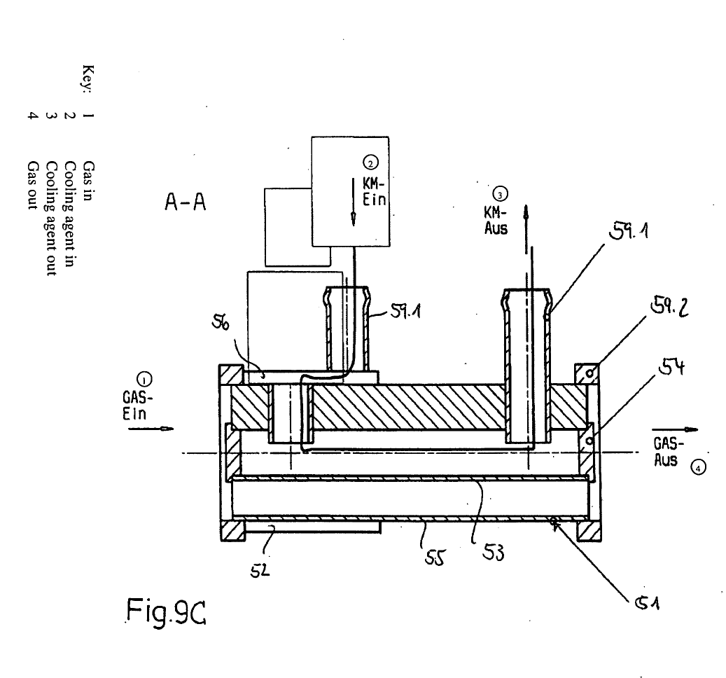

FIGS. 9A-9C show a first embodiment of a gas cooler according to a second variant of a refinement;

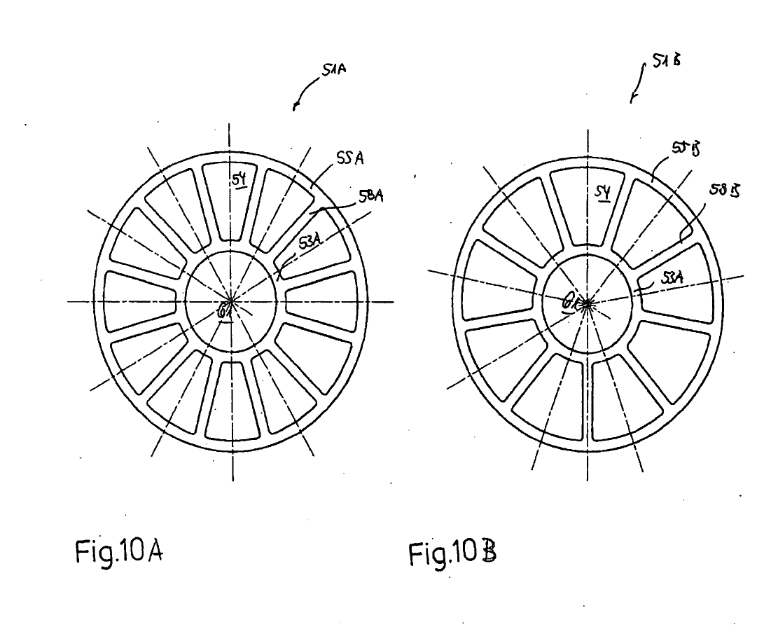

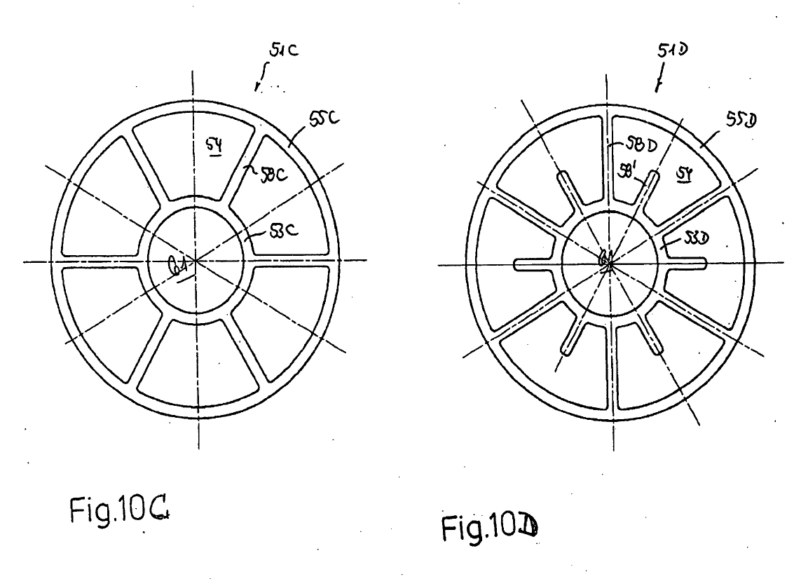

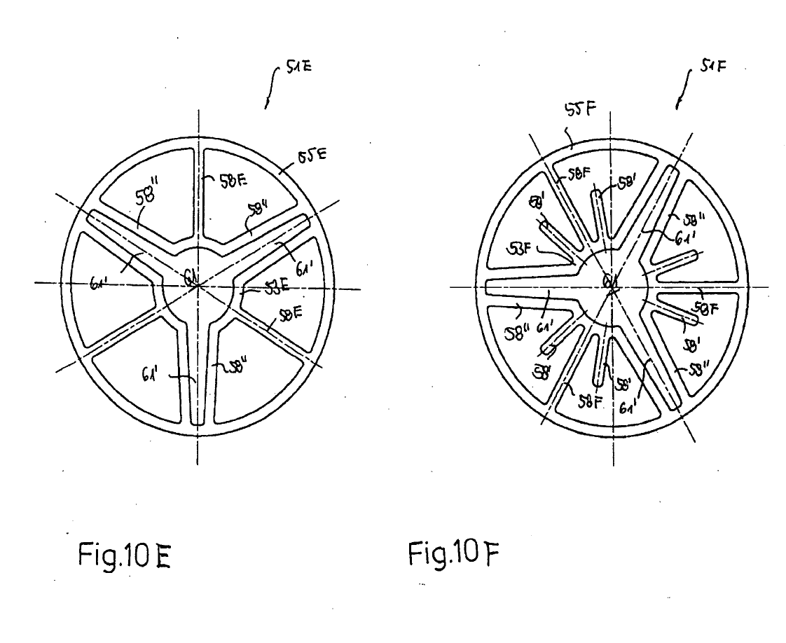

FIGS. 10A-10F show various designs of extruded tubular arrangements with inner and outer tubular parts for an embodiment according to a second variant of a refinement, for example, for an embodiment of FIG. 9A, FIG. 9B;

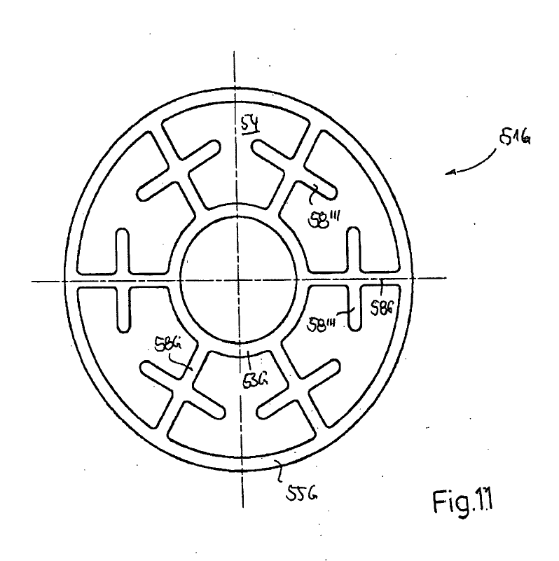

FIG. 11 shows an advantageous modification of an extruded tubular arrangement, by way of example, with additional webs-for example, webs as they can also be arranged with designs from FIGS. 10A-10F;

FIG. 12 shows a first embodiment of a gas cooler according to a third variant of a refinement;

FIG. 13 shows a second embodiment of a gas cooler according to a third variant of a refinement.

The gas cooler depicted in FIG. 1 comprises an inner tubular part 1 which is inserted into an outer tubular part 2. Both tubular parts 1, 2 are constructed as extruded profiles based on aluminum.

A channel 3 is constructed in the inner tubular part 1 to convey exhaust gas from an internal combustion engine. The inner tubular part of an essentially cylindrical outer wall 4 and a number of extensions—a total of ten rib-like extensions 5 projecting radially inwards from the wall 4—are thereby formed. The extensions 5 extend over the entire length of the inner tubular part 1, so that the inner tubular part 1 is constructed as a prismatic body.

The outer tubular part 2 comprises a cylindrical outer wall 6 from which three webs 7 protrude inwards to the wall 4 of the inner tubular part 1. The three webs 7 are placed symmetrically, offset at angles of 120 degrees with respect to one another. Just like the extensions 5 of the inner tubular part 1, the webs 7 extend over the entire length, so that the outer tubular part 2 is a prismatic body. Basically, however, the webs can have interruptions to effect a savings in material or to reduce friction during insertion of the inner tubular part. The same is true for extensions 5, in which suitable interruptions in the longitudinal direction can be used for creation of turbulence in the gas flow.

The inner tubular part 1 has a projection 8 by which it projects beyond the end of the outer tubular part 2. In this way a connecting element 9 can be connected with the tubular parts 1, 2 in a simple manner (see FIG. 1). The connecting element 9 comprises a largely rotationally symmetric metal cap with a connection 10 for entry or exit of the liquid cooling agent. The cap-shaped connecting element 9 is pushed over the outer tubular part 2 and welded to it all the way around to produce a seal, wherein the inner tubular part 1 projects through an essentially circular opening 11 of a front wall 12 of the connecting element 9 and is welded to the edge of the opening to produce a seal. An exhaust gas-conveying tube can be simply welded or attached by means of a sealing agent on the part of the inner tubular part 1 projecting through the front wall 12.

Only one of two end connecting areas of the gas cooler is shown in FIG. 1. The gas cooler can basically be designed symmetrically with regard to its end connections.

The invention functions as follows:

The hot gas flowing though channel 3 has a relatively large contact area with the surfaces of wall 4 and the extensions of the inner tube part 1. In this way the heat energy of the gas is transferred to the metal of the tubular part 1. The cooling liquid flows through a gap 13 which remains between the wall 4 of the inner tubular part and the cylindrical wall of the outer tubular part, and if applicable, the webs 7. In this way, the heat from the material of the inner tubular part 1 is transferred to the cooling liquid flowing through, and finally the heat of the exhaust gas is conducted away via the cooling liquid. The three webs 7, which in similar fashion to the extensions 5 extend rib-like over the entire length of the outer tubular part 2, form via the contact sites with the inner tubular part 1, which could also be made integrally in one piece, only one small and negligible heat bridge between the tubular parts 1, 2. In order to further reduce the size of the heat bridge, the webs can taper in the area of their attachment.

For a good corrosion resistance and higher thermal conductivity with a good manufacturing feasibility, the walls 4 and the webs 5 can be selected between 0.3 mm and 2 mm, in particular, between 0.5 mm and 1.0 mm.

FIG. 4 shows the tubular parts 1, 2 of the gas cooler over their entire length. Two bends 14, 15, relative to the longitudinal axis of the tubular parts 1, 2, are introduced into the tubular parts. These bends 14, 15 allow the gas cooler to be adapted to the available installation space, without substantial hindrance of the gas flow and/or the liquid flow resulting. In the course of production, the two tubular parts 1, 2 are first pushed into one another, and perhaps fixed in their position, with respect to their longitudinal direction. The bends 14, 15 are introduced subsequently, whereby the tubular parts 1, 2 are at the same time fixed to one another in a form-locking manner, so that where appropriate, other steps such as welding the tubular parts to one another are superfluous. For a good corrosion resistance and a high thermal conductivity, with a good manufacturing feasibility, the walls 4 and the webs 5 can be selected between 0.3 mm and 2 mm, in particular, between 0.5 mm and 1.0 mm.

FIG. 5 shows a second embodiment of the gas cooler, in which components with the same function are provided with the same reference symbols as in the first embodiment.

In contrast to the first embodiment, the inner tubular part 1 and the outer tubular part 2 do not have a cylindrical outer circumference, but rather a rounded elongaged cross section. The inner tubular part 1 has an additional bypass channel 16, which is arranged adjacent to the gas channel 3. The channels 3, 16 are enveloped by a common outer wall 4, with a separation wall 17 being arranged between the gas channel 3 and the bypass channel 16.

In contrast to the channel 3 with its extensions 5, the bypass channel 16 has no extensions, so that with the same flow resistance it clearly has a smaller surface area, and thus heat exchange area, with respect to the gas flowing through. In addition, the bypass channel 16 is lined with a metal sheet 18, which confers an additional heat insulation, in particular via an air gap between the wall 17 and the sheet metal 18. However, nondepicted flaps or valve means known from the manufacture of exhaust gas coolers enable initially conducting the exhaust gas flow through the bypass channel 16, for example when cold starting the engine, so that it does not experience any appreciable cooling. Only when the engine is warmed by operation is a cooling of the recirculated exhaust gas desired and required, and for this purpose the gas flow is then conveyed through the flow channel 3.

In the second embodiment, each of the four existing webs 7, which extend from the outer wall 6 of the outer tubular part 2 to the outer surface of the inner tubular part 1, has a rounded end 7a. The rounded or tapered end 7a produces a relatively small contact area of the webs 7 with the wall 4, so that heat transfer between the inner tubular part 1 and the outer tubular part 2 is very small, and almost the entire surface area of the inner tubular part 1 is impinged on by a flow of cooling agent.

For a good corrosion resistance and high thermal conductivity, with a good manufacturing feasibility, the walls 4 and the webs 5 can be selected between 0.3 mm and 2 mm, in particular, between 0.5 mm and 1.0 mm.

FIGS. 6A and 6B depict another advantageous embodiment for a cooling agent-side and/or gas-side connection to a heat exchanger, for example, the cooler of FIG. 1 to FIG. 5. The gas- and cooling agent-side connection takes place via only one closure element 19, which comprises the inflow of both fluids. The incident flow and the connection 19.1 of the fluid to be cooled hereby take place in the longitudinal direction of the cooler, which is not depicted further, whereas the cooling agent-side connection 19.2 is arranged radially with respect to the gas flow direction. The depicted design of a connecting element 19 is in particular an extension of the design of a connecting part with connections 9, 10, already shown in FIG. 1. The gas-side connection 19.1 is hereby advantageously constructed as a so-called V-clip. The webs 20 essentially correspond to the webs 5 for the improved heat exchange.

FIGS. 7D, 7E show yet another advantageous embodiment for a cooling agent-side connection 29.2 and gas-side connection 29.1 to a tubular arrangement 21, of FIGS. 7A-7C. In the end area 22 of the tubular arrangement 21, intermediate webs between the inner tube 23 and the outer tube 25 are removed so that a distribution channel for the cooling agent is produced. Additional holes 27 for the cooling agent connections 29.2 are introduced into the outer tube 25 in the intermediate web-free area 22; the connections are fixed in the holes by means of welding, soldering, bonding, or pressing-in. The gas-side connection 29.1 is implemented via a simple flange. It can either be buttjoined at the end of the inner tube 23 so that the fluid region of the outer tube 25 is covered, or a part of the outer tube 25 can be removed, and the flange then pushed over the exposed inner tube 23 and positioned there. A fixing of the flange is in turn effected by means of welding, soldering, bonding, or pressing-in.

Alternatively, flange connections which comprise both the gas-side and the cooling agent-side connections are also possible. Furthermore, it is provided in another version that the flange connection is constructed so that both the fluid to be cooled, in particular, the gas such as the exhaust gas, and the cooling agent flow into the heat exchanger through the common flange connection.

The representation of the gas-side and cooling agent-side connections disclosed in drawings FIG. 7A to FIG. 7E stands out from the cooler design applied for in Utility Design document DE 203 01 920 U1 in that the cooling agent-side and the gas-side connections 29.1, 29.2 are not jointly introduced into the complex tube connecting pieces, but rather, as described above, the cooling agent connection is directly placed in the outer tube 25 and the gas connection is arranged only in the front area of the inner tube 23, resulting in a practical, simple, and low-cost manufacture.

Another possible embodiment of a cooler 30 is depicted in FIGS. 8A and 8B. In this embodiment, the cooler 30 has at least one gas channel 31 in the form of a segment which is in turn subdivided by at least one web 33 and/or by additional half-webs in at least two parallel gas chambers 35. The gas channels 31 are connected among one another by means of spacer webs 37, so that at least the entire inner block can be produced in one piece. Here, the entire block 41 is extruded. The preferred mode of production for the one-piece design is extrusion by means of an aluminum alloy. Alternatively, a multipiece, for example, a two-piece design is also possible. In the case of the two-piece design, the inner part—that is, the inner block 39, which contains all gas channels 31, including the spacer webs 37—is made in one piece and subsequently joined with a separate housing 40 to form the block 41. For the two-piece design, either two pieces 39, 40 can be produced by extrusion, or preferably, the inner part—that is, the inner block 39—can be produced by extrusion and the housing 40 by a casting or injection molding process. The design of the housing 40 as a casting/injection molded part has the advantage that any mounts and fluid supply/removal connecting parts can also be directly cast/molded. The housing 40 can thus be produced very economically. The connection between the inner block 39 and the housing 40 can be made via either substance-to-substance bonding or a clip connection or a guide strip 43 introduced in the housing.

For a good corrosion resistance and high thermal conductivity, with good manufacturing feasibility, the walls 4 and the webs 5 can be selected between 0.3 mm and 2 mm, in particular, between 0.5 mm and 1.0 mm.

With a multipiece design of the inner part, at least one gas channel 31 with at least one spacer web 37 is made and subsequently assembled to form the complete inner block 39. For the highest possible strength of the inner part, the gas channels 35 can additionally be connected to the spacer webs 37 with substance-to-substance bonding, or alternatively the spacer web ends 37 are shaped such that they are plugged or connected together via a set of guides.

Overall, the inner block 39 can be provided here as an inner tubular part and the housing 40, as an outer tubular part.

For the connection of the not further depicted gas and cooling agent supply to a cooler with the block 41, the spacer webs 38 between the housing 40 and the gas channels 35 are removed in the vicinity of the cooler ends-possibly also the spacer webs 37 between the gas channels 35—so that in the area of the cooler ends, the cooling water flowing around the gas channels 35 can be distributed over the entire cross section 45—that is, the gap between the outer tubular part (housing 40) and the inner tubular part (inner block 39). If the cooling water connections are not directly integrated in the housing 40, then the cooling water is supplied via additional holes in the housing in which a cooling water connecting piece is then used. To separate the gas and cooling agent areas, a flange, not depicted in more detail, is placed at the cooler end. The gas channels of the cooler are hollowed out in the flange so that the flange separates the cooling agent area from the gas area.

In similar fashion to what is described with the aid of FIGS. 1-7E, the flange can, on the one hand, be fixed with a butt join at the cooler ends, or alternatively the cooler housing and the spacer webs can be recessed in the area of the cooler ends by an additional subsequent processing, so that the flange is slid on and welded or soldered with the gas channels.

Alternatively, flange connections which comprise both the gas-side as well as the cooling agent-side connections are also possible.

Basically and in particular, with the embodiment of FIGS. 8A-8B under consideration, all gas and/or cooling agent channels can receive a throughflow in the same direction within the cooler. However, a deflection and return in the direction of the entry side can also be effected by means of an additional deflection at the end of the cooler opposite the gas entry. For this case, the shaping of the gas channels can be made differently for back-and-forth flow.

In addition to the cooler design described according to FIGS. 8A-8B, in which only gas channels with the highest possible number of webs for better heat exchange are provided, a design of the cooler with at least one gas channel with a large number of webs in which the gas is cooled, and a bypass channel in which the fluid is cooled as little as possible—similar to what is shown in FIG. 5—is possible. The gas channel shaped as a bypass channel in this case has a clearly smaller subdivision—or none at all—into individual gas chambers. The flow conveyance between the gas channel(s) with the high web density and the bypass channel takes place via a bypass flap upstream or downstream from the cooler. For a better insulation of the bypass channel, an additional plate—similar to what was explained with the aid of FIG. 5—can be used in the bypass channels that has a defined separation form the tubular wall, so that an additional insulation and thus a reduced heat removal take place in the bypass channel by virtue of the air gap established between the plate and the tubular wall.

The distance between the webs 33 in the gas channels 31 can preferably be selected between 1.5 mm and 6 mm, in particular, between 3 and 4.5 mm. The width of the gas channels 31 can be preferably selected between 20 to 150 mm, in particular, between 25 and 90 mm. If an additional turbulence generator is inserted into the gas channels—for example, in the form of a rib—then webs are dispensed with either entirely or also partially. Values of 2.5-15 mm, in particular, 4-8 mm, are preferred for the inside height of the gas channels 31.

For a good corrosion resistance and high thermal conductivity, with good manufacturing feasibility, the gas channel walls 36 can be selected between 0.3 mm and 2 mm, in particular, 0.5 mm and 1.0 mm.

In comparison to the previously described embodiments, according to a first variant of a refinement it can be advantageous according to a second variant of the refinements not to bring the gas-conveying medium into the interior of the tube, as described before, but rather to convey the cooling agent in the inner tube and the fluid to be cooled—for example, air, or the exhaust gas or air-exhaust gas mixture—in the outer tube area—that is, in the gap between the outer and the inner tube. Such an embodiment of a cooler 50 is shown in FIGS. 9A-9B.

One of the advantages of this design is that the connection of the cooler 50 to the cooling agent and gas provision can be designed in a manner that is clearly simpler, since the cooling agent-carrying inner tube 51 preferably has a circular cross section or a cross section similar to a circular shape. Tube plugs 54, which can be formed very simply, are pressed, soldered or welded into the cooling agent-carrying inner tube 53. These tube plugs 54 are made as a part of a gas-side connection 59.2, preferably, as a simple deep-drawn part. Moreover, a cooling agent entry and exit connecting piece is provided as a part of a cooling agent-side connection 59.1. The corresponding hole for this is (preferably) introduced mechanically, by boring or milling radially to the longitudinal axis of the cooler. The cooling agent connecting pieces are then attached by means of soldering, in particular, flame soldering. For the gas connection 59.2 an additional flange is soldered and/or welded on the outer surface of the cooler. In order not to block the gas channels, the cooling agent connecting pieces should be fixed in the middle to one of the webs 58 between the outer tube 55 and the inner tube 53. The slipping over of a one-piece design of the tube connecting piece, in which the connections of both the first, as well as the second, fluid are integrated, is also possible.

Alternatively, flange connections, which comprise both the gas-side and the cooling agent-side connections, are also possible. Furthermore, provision is made in another version wherein the flange connection is designed so that both the fluid to be cooled, in particular, a gas such as the exhaust gas, and also the cooling agent, flow into the heat exchanger through the common flange connection.

Another advantage of the design with an inside cooling agent channel as in FIGS. 9A, 9B is that the gas-side pressure loss of the tubular arrangement 51 can clearly be lowered. The tubular wall delimiting the cooling agent channel with respect to the gas channel is located closer to the tube center, and thus has a smaller circumference and a smaller cross sectional area, so that a larger cross sectional area is available for the gas channel for the same outside diameter of the cooler.

If the inner tube 53 is made as a round tube, as is the case here, or similar to a round tube, the cross sectional area needed for the cooling agent can be additionally reduced, again in comparison to the previous embodiment, with the same cooling agent-side pressure loss, since with the same cross sectional area, a round tube always has a smaller hydraulic diameter, and, thus, a smaller pressure loss, than a cooling agent channel formed as a gap.

In FIGS. 10A-10F, the designs of the tubular arrangement 51 that are advantageous for use with an interior cooling agent channel are shown as tubular arrangements 51A to 51F.

Accordingly, these have an inner tube 53A-53F and an outer tube 55A-55F, with webs 58A-58F. With a structure that is otherwise the same, the tubular arrangements 51A-51C differ by the number of chambers 54 that are formed in the gap between the outer tube 55A-55C and the inner tube 53A-53C to convey the fluid to be cooled, in this case, a gas. The tubular arrangement 51A has 13 chambers 54; the tubular arrangement 51B has nine chambers 54. The tubular arrangement 51C has six chambers 54. The preferred selection of hydraulic cross sections, formulated with regard to the subclaims, is to be applied to such chambers 54.

For reasons having to do with strength, the maximum component temperature of the outer tube should not be greater than 300° C. At gas temperatures of up to 600° C., as can be expected when using the cooler for an internal combustion engine, as high as possible a thermal conduction in the webs 58A-58F is, in particular, desired from the inner tubular part 53A-53F to the outer tubular part 55A-55F-that is, in particular, at the cooling water tube. This is obtained, on the one hand, by a sufficiently large web thickness with the webs 58A-58F, in particular, 58A-58D, of 0.6-3 mm, preferably, 1-2 mm, and, on the other hand, also by a possible profitable one-piece construction of the cooler.

For uses in which, for the given general conditions, a comparatively high or excessively high outside tube temperature would be established, another advantageous cooler design 50′ according to FIG. 9C can be preferably selected, wherein parts with the same function are otherwise provided with the same reference symbols. In the front tube area, another tube 52 is here pushed over the tube arrangement 51. The gap between the additional tube 52 and the outer wall of the cooler forms another cooling agent channel 56. The cooling agent now initially flows-as located by the corresponding line-between the additional tube 52 and the outer wall of the cooler against the gas flow, and is then transferred to the actual cooling agent tube in the area of the gas inlet. In this way, the tubular wall temperatures in the critical front area of the cooler are clearly reduced. For reasons of space, the length of the additional tube 52 has to be selected to be as short as possible, preferably smaller than ⅓ the total length of the cooler, in particular, smaller than ⅕ of the total length of the cooler. Advantageously, the additional tube 52, including the cooling agent connecting pieces, the gas flange, and the closure cap for the inner cooling agent tube, can be made as one piece, in particular, as a casting.

For reasons having to do with corrosion and strength, it is desirable to make the wall and web thicknesses of the tube arrangement 51, in particular, the outer tube 55 and/or the inner tube 53—that is the cooler tube—between 0.6 and 3 mm, preferably between 1 and 2 mm.

To enhance the heat exchange, it is desirable—in particular, on the gas side—to offer as large as possible a cooling surface. This is attained in that in addition to the connecting webs between the outer and the inner tubes, additional partial webs 58′ are attached—here, preferably on the outside of the cooling agent tube, as is shown in FIGS. 10D and 10F. In FIGS. 10E and 10F are shown designs 51E and 51F in which a web 58″ is made hollow and, thus, can be cooled from the inside. The otherwise round cross section of the central interior 61 of the inner tube 53E, 53F, thus, expands into the webs 58″ with radial cross sectional runners 61′.

In a manner analogous to that explained above with the aid of FIG. 4, a tubular arrangement 51A-51F of FIG. 10A-FIG. 10F can also be bent or twisted about at least one longitudinal axis or transverse axis. The heat exchange is advantageously increased by the gas deflection in the area of the bend. As shown in the tubular arrangement 51G in FIG. 11, additional transverse webs 58″ on the webs 58 or partial webs 58′ between the inner and outer tubes 53G, 55G can increase the flow turbulence yet more, in addition to increasing the heat-exchanging surface, in particular, in the tube bend area, since they have a (more) directly incident flow because of the tube bend, and, in this way, improve the heat transfer.

Another possibility to increase the performance of the heat exchanger and to limit the outer temperature of the cooler tube wall is to be found in having a flow through the tube chambers that alternates between the cooling medium and the medium to be cooled, as is shown with the tubular arrangements 51H and 51K in FIGS. 12 and 13 for a cooler 50. Whereas the fluid to be cooled flows in axially in the depicted version, the cooling agent is supplied in a manner radial to the tube via a distribution channel. In the tube inlet and end area, every other chamber 54.2 is, for this purpose, opened toward the distribution channel, so that the fluid can be distributed, as desired; a tubular cross section of the tubular arrangement 51H, as is shown in FIG. 12(D), is particularly suitable. The separation between the two fluids takes place in the area of the distribution channel via an additional cap. All construction parts can be welded, soldered, bonded or mechanically joined as desired. In addition to the design of the tubular arrangement 51H of FIG. 12(D), a design, or also similar designs with additional half-webs like those in FIG. 12 are preferred for the alternating throughflow of the two fluids in the cooler. In this way, a pressure loss in the fluid to be cooled is reduced. Designs are also possible in which every two adjacent chambers receive a throughflow of the fluid to be cooled and only the two adjoining chambers a flow of the cooling fluid. With particular preference, the gas-conveying chambers are made larger in their cross sectional area than the cooling agent-conveying chambers, in particular, so as to obtain as low as possible a gas-side pressure loss with optimal cooling. In particular, the cross sectional area of the gas-conveying chamber is 1.5-5 times as large as the cross sectional area of the cooling agent-conveying chamber.

A tubular arrangement design for the alternate filling of the chambers similar to that of 51H is depicted as tubular arrangement 51K in FIG. 13. In this design, either the fluid to be cooled or the cooling fluid can be conducted in several separate chambers 61″, which, in particular, are made circular with possibly additional cooling webs. All chambers are connected by means of webs as a part of the inner tube 53K, so that this embodiment can also be produced in one piece. Due to the web bond 58K between the tubes 53K, 55K, this embodiment has, like all previous designs, a very high strength; a bracing of the tubes 53K, 55K, against one another, as is necessary with classical tubular bundle heat exchangers, is not needed for this cooler design.

In summary, the invention concerns a heat exchanger for the cooling of a fluid for an internal combustion engine, in particular, a gas, for example, in the form of a charge fluid such as exhaust gas, a charge air, mixtures thereof, or the like, in particular, for an internal combustion engine of a motor vehicle; preferably a gas cooler with an inner tubular part with at least one channel and an outer tubular part, wherein according to the invention, there is a web on at least one of two tubular parts, an inner or an outer one, wherein the web extends to the other of the two tubular parts, the inner part or the outer part.

1. A heat exchanger for the cooling of a fluid for an internal combustion engine of a motor vehicle, the fluid comprising a gas, comprising
an inner tubular part with at least one channel for conveying the fluid to be cooled, and an outer tubular part, and a web, wherein
the web is located on at least one of the inner tubular part or the outer tubular part, wherein the web extends to the other of the inner tubular part or the outer tubular part.

2-4. (canceled)

5. The heat exchanger according to claim 1, further comprising
a gap formed between the outer tubular part the inner tubular part for conveying a liquid cooling agent.

6. (canceled)

7. The heat exchanger according to claim 1, wherein
the inner tubular part comprises aluminum, and the outer tubular part comprises plastic.

8. The heat exchanger according to claim 1, wherein
at least one of the inner and outer tubular parts is made of an aluminum alloy, which has a Cu fraction that is lower than 0.5 wt %.

9. The heat exchanger according to claim 1, wherein
at least one of the inner and outer tubular parts is made of an Al—Mg—Si or an Al—Zn—Mg alloy.

10. The heat exchanger according to claim 1, wherein
at least one of the inner and outer tubular parts is made of an aluminum alloy, which has:
an Si fraction of less than 1.0 wt %;
an Fe fraction of less than 1.2 wt %;
a Cu fraction of less than 0.5 wt %;
a Cr fraction of less than 0.5 wt %;
an Mg fraction of more than 0.02 wt % and less than 0.5 wt %;
a Zn fraction of less than 0.5 wt %;
a Ti fraction of less than 0.5 wt %;
the balance, Al and unavoidable impurities.

11. The heat exchanger according to claim 10, wherein at least one of the inner and outer tubular parts has an
Si fraction below 0.6 wt %.

12. The heat exchanger according to claim 10, wherein at least one of the inner and outer tubular parts has an
Fe fraction of below 0.7 wt %.

13. The heat exchanger according to claim 10, wherein at least one of the inner and outer tubular parts has a
Cr fraction of above 0.05 wt % and below 0.25 wt %.

14. The heat exchanger according to claim 10, wherein at least one of the inner and outer tubular parts has an
Mg fraction of above 0.05 wt % and below 0.3 wt %.

15. The heat exchanger according to claim 10, wherein at least one of the inner and outer tubular parts has a
Zr fraction of above 0.05 wt % and below 0.3 wt %.

16. The heat exchanger according to claim 10, wherein at least one of the inner and outer tubular parts has a
Ti fraction of above 0.05 wt % and below 0.25 wt %.

17. The heat exchanger according to claim 10, wherein at least one of the inner and outer tubular parts has an
aluminum alloy of another fraction, selected from the group consisting of: Mn, Zr, Ni, V, Co, Pb, Ga, O.

18. The heat exchanger according to claim 10, wherein
the aluminum alloy has another fraction in a range of 0.05 wt % to 0.15 wt %.

19. (canceled)

20. The heat exchanger according to claim 1, wherein
the inner tubular part has rib-like extensions, which project into the channel for conveying the fluid to be cooled.

21. The heat exchanger according to claim 1, wherein the
inner tubular part has at least one second channel, wherein the second channel is designed as a bypass channel with a reduced cooling of the throughflowing gas.

22-36. (canceled)

37. The heat exchanger according to claim 1, wherein
the inner tubular part has an interior space with a cross section that has at least one radial extension adjacent to the interior space, the radial extension being circumferentially delimited by the outer tubular part.

38-55. (canceled)

56. An exhaust gas recirculating system for an internal combustion engine comprising a supply conduit for combustion air to supply air for combustion to an inlet of the internal combustion engine, an exhaust gas conduit for removal of the exhaust gas from an outlet of the internal combustion engine, and an exhaust gas recirculating conduit to return exhaust gas from the exhaust gas conduit to the combustion air supply conduit, and
a heat exchanger according to claim 1 for cooling of the air for combustion and/or the exhaust gas located in the supply conduit for combustion air, in the exhaust gas conduit, and/or in the exhaust gas recirculation conduit.

57. The exhaust gas recirculating system according to claim 56,
further comprising
an exhaust gas turbocharger with a compressor in the supply conduit for combustion gas and a turbine in the exhaust gas conduit, wherein the exhaust gas recirculating conduit is located on a high pressure side or on a low pressure side of the exhaust gas turbocharger.
